(19) United States
(12) Patent Application Publication
(10) Pub. No.: US 2009/0097377 A1
(43) Pub. Date: Apr. 16, 2009

(54) Secured Optical Information Carrier, and Data Encryption Method and Apparatus for Recording Data in the Optical Information Carrier

(75) Inventors: Yair Salomon, Jerusalem (IL); Andrew Shipway, Jerusalem (IL)

Correspondence Address: HOUSTON ELISEEVA, 4 MILITIA DRIVE, SUITE 4, LEXINGTON, MA, 02421, US

(73) Assignee: MEMPILE INC., Wilmington, DE (US)

(21) Appl. No.: 12/249,219

(22) Filed: Oct. 10, 2008

Related U.S. Application Data
(63) Continuation of application No. PCT/IL2007/000447, filed on Apr. 10, 2007.
(60) Provisional application No. 60/790,567, filed on Apr. 10, 2006.

(51) Int. Cl. G11B 7/00

(52) U.S. Cl. 369/100; 369/275.3; G9B/7

(57) ABSTRACT

An optical information carrier and method and apparatus for securing the carrier are presented. The optical information carrier comprises a recording medium for recording data therein in the form of a first pattern of spaced-apart recorded regions configured to provide a first optical response to incident light, and comprises a pattern of spaced-apart regions configured to respond to incident light by a second optical response pattern. Distribution of the spaced-apart regions forming the second optical response pattern is indicative of an individual and identifiable carrier specific signature.

### RELATED APPLICATIONS

This application is a Continuation of PCT application serial number PCT/IL2007/000447 filed on Apr. 10, 2007, which claims the benefit under 35 USC 119(e) of U.S. Provisional Application No. 60/790,567, filed on Apr. 10, 2006, both of which are incorporated herein by reference in their entirety.

### FIELD OF THE INVENTION

The present invention is generally in the field of optical memories, and relates to an optical information carrier protected from unauthorized use, and a method and apparatus for recording/reading data therein.

### BACKGROUND OF THE INVENTION

Optical information carriers are widely used in the computer and entertainment industry. The optical information carriers usually have a disc like form, although other carrier shapes are known in the art. The information is recorded on the disc like carrier in the form of so-called marks or data marks.

The existing approach for optical information carriers is based on the use of reflective recording media. Accordingly, commercially available optical information carriers have one or two data layers.

According to an alternative approach, data marks are optically recorded in optical information carriers made of non-linear optical material (recording media) such as polymer materials exhibiting multi-photon absorption. This technique is disclosed for example in WO 01/073779, WO03070689, both assigned to the assignee of the present application. In such carriers, marks are present as local variations of material optical properties. More specifically, the optical material has a fluorescent property variable on occurrence of multi-photon absorption resulted from an interaction with a recording or reading optical beam. Other non-linear responses such as Raman Scattering and various other four-wave mixing processes are optional, as described in WO03077240 to the same assignee.

Typically, the carrier is interrogated with electro magnetic radiation at an excitation wavelength. As a result of the interaction between the electro magnetic radiation and the recording media the mark emits a fluorescence signal at a wavelength different from the excitation wavelength. This signal is read/retrieved and interpreted as recorded information or data. Information stored in such information carrier is in the form of a three dimensional pattern of spaced-apart recorded regions, which are preferably located in multiple virtual layers.

Through the text of the present disclosure the words information and data have the same meaning, and also the terms retrieving and reading have the same meaning.

Relative movement between the carrier and the recording or retrieving spot of focused electro magnetic radiation, such as laser radiation, enables the information recording and retrieving processes. Typically, the disc rotates and the focused spot generated by a laser and imaged by an optical pick-up head (OPU) moves across the disc. The disc rotation speed is somehow limited, and in order to increase the information recording or retrieving speed the use of a plurality of reading/retrieving heads have been proposed (e.g. U.S. Pat. No. 5,189,652, U.S. Pat. No. 5,574,881, U.S. Pat. No. 5,631,893, U.S. Pat. No. 6,567,364 and U.S. Pat. No. 6,785,198).

Some of the data recorded on the disc represents software, video, audio, and other entertainment articles that should not be free copied. In order to prevent non-authorized copying of the disc content, the recorded data is encrypted and the recording/retrieving apparatus or drive recognizes the encryption system. Some of the discs in addition to encrypted data include authentication features (such as digital fingerprint or signature) that allow distinguishing them from discs supplied by non-authorized disc manufacturers. These techniques are disclosed in US2003072447, US2004168025, US2004145986.

A known security standard for optical media is provided by AACS LA LLC 3855 SW 153rd Drive Beaverton, Oreg. 97006. Known encryption techniques are described in U.S. Pat. Nos. 5,627,805; 6,381,210; 6,567,364; 6,589,626; 6,838,145 and 6,952,392. Same of the techniques for simultaneous recording and retrieving data from a plurality of locations on an optical carrier are described in U.S. Pat. Nos. 6,381,210; 6,411,573; 6,449,225.

### SUMMARY OF THE INVENTION

The existing carrier authentication, encryption and recording/retrieving data methods are not interrelated and each of them has different origins providing space for violation of copy rights and use of non-authorized carriers. Secure simultaneous data recording and retrieving in/from a plurality of locations requires coordination of the recording and retrieving processes and association with particular carrier fingerprint (signature).

There is accordingly a need in the art for a technique that would interrelate carrier-fingerprinting, encryption and recording/retrieving data methods. There is an additional need in methods and apparatuses enabling high-speed simultaneous data recording and retrieving in/from a plurality of locations that are associated with particular carrier fingerprint (signature) and/or controlled digital rights management (DRM), i.e. systems to be used by publishers or copyright owners to control access to and usage of digital data or hardware, and to restrictions associated with a specific instance of a digital work or device.

The present invention solves the above problems by providing a novel optical information carrier, and encryption technique enabling recording/reading data therein and identifying the carrier specific signature for authentication of the carrier.

According to one aspect of the invention, there is provided an optical information carrier, comprising a recording medium for recording data therein in the form of a first pattern of spaced-apart recorded regions configured to provide a first optical response to incident light, and a pattern of spaced-apart regions configured to respond to incident light by a second optical response pattern, distribution of said spaced-apart regions forming the second optical response pattern being indicative of an individual and identifiable carrier specific signature.

The recording medium may be a non-linear medium, namely a medium having a fluorescent property thereof variable on occurrence of multi-photon absorption (e.g. two-photon absorption) resulted from interaction with an optical beam as disclosed in various patents and patent applications assigned to the assignee of the present application; or may be a (semi) reflective medium as used in the conventional optical data carriers. The pattern of spaced-apart regions forming the second optical response pattern may be in the form of particles embedded in the recording medium and/or in a substrate below or above the recording medium.

The particles are configured to provide a detectable optical response to incident light, such that this response is different from that of the data pattern (i.e. recorded regions and spaces between them). For example the particles respond to incident light by light of a wavelength different from the optical response of the data pattern, while the incident light used for generating the particles' response and for generating the data pattern response may be of the same or different wavelengths. In the latter case, first and second different light sources may be used for producing incident light of first and second wavelengths, respectively.

Preferably, the above is implemented by including in the particles an optically active material different from the optically active material of the recording medium, for example the particles may include an absorbing material, which may fluoresce with fluorescence of a wavelength different from that of recording regions and/or spaces between them in a non-linear recording medium; or from the recording/reading light wavelength in case of (semi)reflective recording medium.

According to another aspect of the invention, there is provided an optical information carrier, comprising a recording medium formed of a first material having a first optical response to an optical beam; and inhomogeneities distributed in the first material and being introduced by a second material or voids having a second different optical response to an optical beam, the distribution of the inhomogeneities forming the second optical response distribution pattern being indicative of an individual and identifiable carrier specific signature.

In some embodiments of the invention, the inhomogeneities are randomly distributed in the first material.

Preferably, the second optical response is fluorescence or absorbance. As for the first optical response, in some embodiments it is also fluorescence induced by the first material interaction with the optical beam, and is different from the second fluorescence. The materials may be selected such that the first and second optical responses are inducible by the same or different wavelength of optical beam. The first material may be selected such that the fluorescent property thereof is variable on occurrence of multi-photon absorption (e.g. two-photon absorption) resulted from interaction with the optical beam. The fluorescent property of the second material may be inducible on occurrence of one-photon absorption resulted from interaction with the optical beam. In some other embodiments of the invention, the first material is a reflective one, the first optical response thus being in the form of reflection of the optical beam.

The information carrier of the present invention is preferably configured for recording and reading data in the form of a three-dimensional pattern of spaced-apart recorded regions located in multiple planes (e.g. virtual layers).

Preferably, the inhomogeneities comprise particles (e.g. microspheres) including the second material. In some embodiments of the invention, the particles include at least some ingredients of the first material. The recording medium may be a pre-prepared mixture of the first material and the particles. Alternatively, the particles may be introduced into specific locations within the first material (e.g. on intermediate surfaces of the first material volume) by an intermediate ink jet printing.

Preferably, at least part of information on the second optical response distribution pattern is also used as a private key for encryption/decryption of data stored in the carrier.

According to yet another broad aspect of the invention, there is provided a method for use in securing an optical information carrier, the method comprising: providing a carrier having a recording medium formed by a first material having inhomogeneities of a second material distributed in the first material, the first and second materials having different optical responses to electromagnetic radiation, thereby enabling detection of the second optical response distribution pattern indicative of an individual and identifiable carrier specific signature and enabling employing said signature for securing the use of recorded information and the information carrier.

According to yet further aspect of the invention, there is provided a method for use in recording data to or retrieving data from an optical information carrier, the method comprising: concurrently applying to the data carrier using at least two recording processes or at least two retrieving processes, and using a carrier specific signature for coupling between the concurrently applied processes.

According to yet another aspect of the invention, there is provided a method for use in securing an optical information carrier, the method comprising: identifying an individual carrier specific signature embedded in the carrier, and utilizing at least a part of said signature as a private key for encryption/decryption of information stored in the carrier, thereby securing the use of recorded information and the information carrier.

The signature may be retrieved from a plurality of locations simultaneously (e.g. by flood lighting and imaging).

The data may be recorded in or retrieved from a plurality of locations simultaneously.

The data recording-in and retrieving-from a plurality of locations in the information carrier can be arranged and protected by using the following: employing a data distribution key to arrange data into recording tasks; registering and directing the recording tasks to a plurality of locations in the carrier; retrieving the register and retrieving data from a plurality of locations on the carrier, and employing said carrier signature to protect at least one of data, data distribution and task registration.

The data interleaving for recording and retrieving data in the information carrier may be carried out as follows: acquiring the carrier signature; using this signature for generating an encryption code, and employing this code for encryption of interleave locations addresses.

It should be noted that, considering fluorescent or absorbing inhomogeneities, the second optical response can be detected by measuring the fluorescence from the inhomogeneities, or alternatively by measuring absorbance of the particles by collecting light as it exits the data carrier and measuring the light modulation. The latter case advantageously provides much wider and cheaper selection of dyes (fluorophores) and provides for collection of more light from the inhomogeneities thus increasing signal to noise ratio.

According to yet another broad aspect of the invention, there is provided an optical apparatus for use in data recording-in and retrieving-from the above-described information carrier. The apparatus comprises at least one optical unit comprising: an electromagnetic radiation source system configured and operable to irradiate the carrier with at least one optical beam to cause the first optical response from the carrier, to be used for data detection, and the second optical response from the carrier; an electromagnetic radiation detection system configured and operable for detecting the second optical response pattern to derive the carrier signature; and a controller utility configured and operable for using said derived signature for distribution key and/or for securing the use of at least one of the data, and the information carrier.

According to yet further broad aspect of the invention, a signature can be used as a key to secure data recorded by more than one optical unit thereby enabling enhanced data security and protection. Thus, a method is provided for use in protecting an optical information carrier, the method comprising: identifying an individual carrier specific signature embedded in the carrier, and utilizing at least a part of said signature as a key to secure data recorded in said carrier by at least two optical units.

The derived signature can be used as a key to distribute data among more than one optical unit thereby enabling enhanced data security and protection.

The electromagnetic radiation source system may utilize the same light source for irradiating the carrier to cause the first and second optical responses; or may include first and second light sources for irradiating the carrier to cause the first and second optical responses, respectively.

### BRIEF DESCRIPTION OF THE DRAWINGS

In order to understand the invention and to see how it may be carried out in practice, embodiments will now be described, by way of non-limiting example only, with reference to the accompanying drawings, in which:

FIGS. 1A and 1B are schematic illustrations of the top view and cross section of an exemplary embodiment of a three dimensional optical information carrier.

FIG. 1C exemplifies an optical information carrier of the present invention of a type utilizing multiple plates of non-linear recording media spaced by reflective reference surfaces.

FIG. 1D shows yet another example an optical information carrier of the present invention of a type utilizing reflective recording medium.

FIGS. 2A and 2B are schematic illustrations of the top view and cross section of an exemplary embodiment of a three dimensional optical information carrier in which data is recorded and retrieved according to the technique of the present invention.

FIG. 3A is an example of a data recording process in the three-dimensional optical information according to the invention.

FIG. 3B exemplifies a method of a (secured) data retrieving process according to the invention.

FIG. 4A exemplifies a track sector structure suitable to be used in the information carrier of the present invention;

FIG. 4B illustrates more specifically an example of the content of the header part of the track sector of FIG. 4A;

FIG. 5 is a block diagram of an example of an apparatus for simultaneous data recording or retrieving in a plurality of locations in the information carrier; and

FIGS. 6A and 6B schematically illustrate examples of utilizing the arrangement or ordering of optical pick-up units to affect data recording/reading.

### DETAILED DESCRIPTION OF THE PREFERRED EMBODIMENTS

The principles and execution of the optical information carrier, method and apparatus described thereby may be understood with reference to the drawings, wherein like reference numerals denote like elements through the several views and the accompanying description of non-limiting, exemplary embodiments.

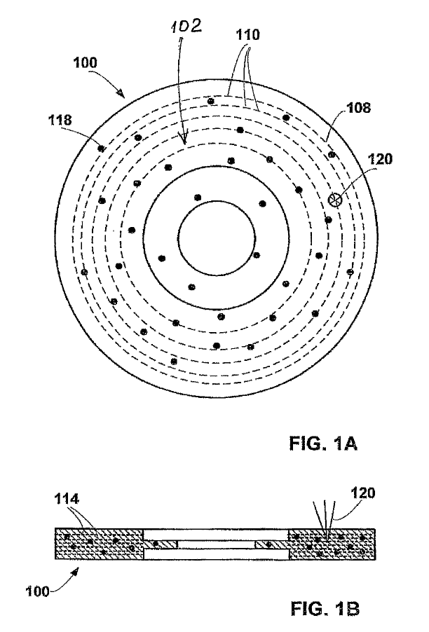

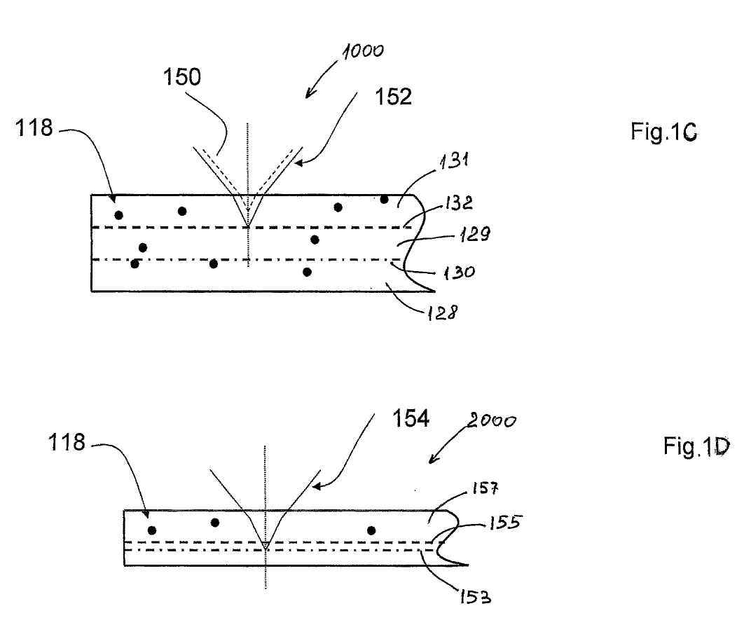

Reference is made to FIGS. 1A and 1B exemplifying the top and cross sectional views, respectively, of a three-dimensional optical information carrier 100 suitable to be used in the present invention.

Generally, the information carrier may include a conventional reflective-type recording medium. In this case, data is recorded in/retrieved from a partially reflective layer.

Preferably, the information carrier 100 utilizes non-linear recording media in which data can be recorded/read on occurrence of multi-photon (e.g. two-photon) absorption. Such a recording medium is disclosed in various patent applications and patents assigned to the assignee of the present application. For example Patent Convention Treaty (PCT) publications WO 01/073779, WO03077240, WO 06/075327, WO 07/010,519, all assigned to the assignee of the present application, disclose non-linear three dimensional information carriers for storing information in a volume comprising an active moiety, capable of changing its state from one isomeric form to another upon interaction with electromagnetic energy, which active moiety is bound to polymer. These patent publications are incorporated herein by reference with respect to specific examples of the invention utilizing non-linear recording media.

Carrier 100 may be a monolithic disc like body or an assembly of a plurality of plates attached to each other and made of a transparent or translucent polymer material, such as Poly(methylmethacrylate) (PMMA) and compositions including acrylate and methacrylate monomers. Examples of three-dimensional carriers assembled from a plurality of plates are disclosed in U.S. patent application Ser. No. 11/290,818 to the same assignee, which is therefore incorporated herein by reference. An active moiety, capable of changing its state from one isomeric form to another upon interaction with electromagnetic energy, such as laser radiation, is bound to polymer 102. The active moiety exhibits two-photon absorption, as disclosed in WO 03/070689, WO2006075327, and WO07010519, to the same assignee, and compositions with bound to it active moiety could be used as a three-dimensional optical information carrier and through the text of the present disclosure will be termed first material or first optically active material.

Particular examples of photochromic-modified monomers are polymerizable active chromophore monomers of the following formula (I) and (II) (also referred to herein as “eMMA” and “eAA”, respectively):

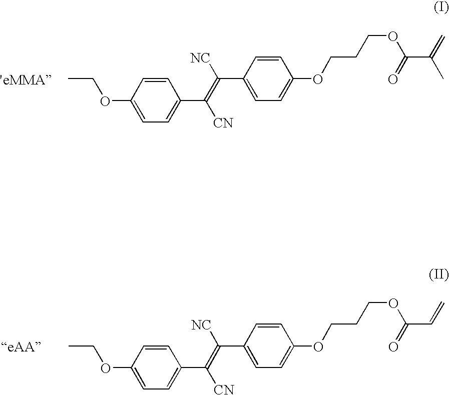

Information is optically recorded in carrier 100 in the form of a three-dimensional pattern of spaced-apart marks or data marks 108 which can be recorded in practically any location, although it is convenient to record the marks along so-called data tracks or tracks 110 on a plurality of “virtual” layers 114 disposed within the disc. Tracks 110 may be of nominal circular or spiral form. Virtual layers 114 may be located at different depths of carrier 100.

The information is optically retrieved from carrier 100 by interrogating recorded marks 108 with electromagnetic radiation, which may be laser radiation, having certain wavelength and power. Interaction of recorded mark 108 with laser radiation results in fluorescence emission by the mark region 108 which is different from an optical response of regions within the spaces between the marks. An optical response pattern from the marks 108 and spaces between the marks represents the recorded data. The fluorescence emission will be referred to as first response.

In case of a partially reflective layer, the first response is the reflected laser beam.

According to the present invention, the recording media of carrier 100 includes a first material 102 (e.g. polymer or partially reflective material) having inhomogeneities (particles) 118 which are intentionally introduced with certain distribution (e.g. random distribution) inside the first material 102. These particles include a second optically active material having a second, different from the first material, optical response. This is because the first and second materials include different optically active ingredients. For example, the second material may include the same optically responsive media as the first material and additionally include some different ingredients. Thus, the optical response of the second material means the optical response of the additional ingredients only. Particles 118 of the second material may be of regular shape, such a micro spheres, or of irregular shape such as fine milled powder mixed with the first material. Actually, particles 118 present inhomogeneities introduced into a substantially homogenous first material of the recording media. Particles 118 may be introduced in small quantity so as substantially not to interfere with the first response.

As mentioned above, a three dimensional carrier may be manufactured by attaching to each other a plurality of thinner plates made of the same material as a monolithic carrier. Data can also be recorded or embossed or coated in the interface layers between the 3D recording plates.

Particles 118 (constituting a second material of the recording media) can be introduced in any controlled, arbitrary and typically small concentration (<1% wt) into the raw polymer material 102 (first material) and mixed until they are randomly distributed within the first material 102. Carrier 100 may be produced from such a mixture by casting, molding or injection molding. WO 2006/111972 and WO 2006/075327, both to the same assignee, disclose methods of manufacture of optical information carriers by casting, molding or injection molding techniques. WO 2006/075327 also discloses methods of manufacturing polymer compositions formed of first optically active material 102 for 3D optical storage. Methods of micro-particles manufacture are known in the art. One of the suitable methods is the preparation of a bulk polymerized article, grinding and sieving particles in appropriate dimension range, other methods such as emulsion polymerization and dispersion polymerization are also optional. Methods for manufacturing of a polymer bulk article which also include dye additives are disclosed in WO 06/075326 to the same assignee. These techniques can be used for the preparation of polymer bulk articles comprising the first material 102 and the second material ingredients 118. Some examples of these techniques are elaborated below.

In some embodiments of the invention, the particles are formed of the second material which comprises the chromophore (which is also included in the first material) and one or more other different material, thereby ensuring that the particles have no significant refractive index difference from that of the first material.

In some other embodiments, crossed linked micro-particles composed of a copolymer of methylmethacrylate (MMA) and eMMA, the fluorescent dye and a cross-linker are homogeneously mixed in partially polymerized MMA/PMMA/BPO mixture. The cross linking ensures that in the casting process the micro-particles are not dissolved in the mixture. If alternatively the micro-spheres are mixed with already polymerized pellets for extrusion an injection molding the cross linking ensures that the micro-particles do not melt at injection molding temperatures.

The micro-spheres may be introduced to the casting process (which is described in the above indicated publication WO 06/075327 to the same assignee), after filtering the polymerizing mixture. The mixture is constantly steered, thereby also preventing micro particles precipitation. When the viscosity of the mixture becomes high enough, the mixture is injected into the casting mold. In this case, smaller micro-spheres can be used, since they will swell when introduced to the liquid monomer mixture

Particles 118 may be responsive to the radiation used for data recording or retrieving procedures, or may be responsive to auxiliary radiation such as a second radiation wavelength used to track a reference layer, if any. For example, the information carrier may include a recording layer composed of a material having a fluorescent property variable on occurrence of multi-photon absorption resulted from an optical beam, reference layer(s), and possibly also one or more non-recording layers formed on upper and/or lower surface of the recording layer and differing in fluorescent property from the recording layer. The reference layer may have a reflecting surface and present an interface e.g. between recording plates or a recording plate and a non-recording layer (e.g. surrounding of the data carrier). The reference layer has a pattern configured for detecting effects of focusing of a recording/reading beam and focusing of a reference beam independent of the recording/reading beam. The pattern in the reference layer may be in the form of an array of spaced-apart pits of a predetermined depth (e.g. selected to maximize a servo signal used for tracking). This technique is described in Patent Convention Treaty (PCT) application PCT/IL2006/001425 assigned to the assignee of the present application, which patent application is incorporated herein by reference with respect to this specific example.

When the recording medium is irradiated by a recording or reading optical beam, particles 118 provide an optical response different from that of their surroundings. Thus, the second material optical response has no substantial interference with the first material optical response. The second material response may be emission of fluorescence at a second wavelength different from the wavelength emitted by data marks 108. The second material response may not be confined to a specific or single wavelength: material responding by a plurality of wavelengths not interfering with the first material response may be employed. Inhomogeneities (particles) of several types, each type providing a different response, all being different from the first response, may be employed.

In some embodiments of the invention, when interrogated by a laser beam the first material provides a multi-photon response (e.g. two-photon response), while the second material provides a one-photon response. In this case, the multi-photon absorbance is used for interrogating/exciting an active ingredient, such as chromophore, included in bulk of the first material (see the U.S. patent application Ser. No. 11/285,210 “Three-Dimensional Optical Memory” to the same assignee). The same interrogating/excitation beam can be used for one photon excitation of a fluorescent material included in the particles of the second material. There is no overlap between the two materials response signals and they can thus be easily differentiated for data reading and carrier authentication processes.

As indicated above, the second material (particles) in addition to the second optically active ingredient may include the optically active ingredients of the first material. This will cause the second material to respond to the interrogating beam by a first response generated by the ingredients of the first material and an additional second optical response generated by the second material.

In an alternative embodiment, particles 118 are either absorbing (substantially non-fluorescent) or optically passive particles or voids

Particles 118 of the second material may be randomly or homogenously distributed within first material 102, and their spatial locations in the carriers/disc 100 present, in extremely high probability, an individual distribution pattern. When interrogated by the recording/reading laser wavelength, particles 118 generate the optical response (the second material optical response) which does not interfere with the first material optical response. Thus, the second material optical response presents an individual, carrier specific, distribution pattern of an optical property (e.g. fluorescence), being a carrier specific, individual and identifiable fingerprint. Fluorescent properties of particles 118 may be selected such that the interrogating laser wavelength used for the carrier authentication is the same as the recording or retrieving laser beam wavelength.

This specific to each carrier 100 analog fingerprint may be detected at the factory, digitized, encrypted and securely recorded in the disk. Digitized representation of the second material optical response distribution pattern is employed as a part of a private encryption key system. Private Key in the context of the present disclosure means a carrier specific secret component of an integrated asymmetric key pair. The principles of the asymmetric encryption scheme (also termed public-key encryption) are known per se and therefore need not be specifically described, except to note that this scheme uses two keys, a public key known to everyone and a private or secret key known only to the recipient of data, where the public and private keys are related in such a way that only the public key can be used to encrypt data and only the corresponding private key can be used to decrypt this data and that such key may be used to provide a key hierarchy.

When a blank or recorded carrier 100 is inserted into a drive, the drive operates for authenticating the disk identity by validating its fingerprint. Authenticating actions may include decryption of a digitized form of the fingerprint, and detection and restoration of essential parts of the fingerprint. Following the carrier authentication, its use for data recording or retrieving purposes is approved. It should be noted that the drive contains the respective key or is capable of accessing it (for example, through Internet). This ensures that the data recorded on the carrier is protected from non-authorized copying, recording data onto the carrier without proper certificates would be improvident (leading to non-retrievable data), and that carriers only from an approved supplier are used.

The resolution in which the particles 118 locations are recorded and retrieved is important for the uniqueness of each fingerprint or carrier ID. Higher resolution in the determination of the locations of particles 118 exponentially expands the possible number of carrier fingerprints and enhances this technique as a method for carrier fingerprint determination.

Fluorescent particles are characterized by a relatively large response radius. They can be easily detected in course of carrier manufacture and when inserted in a drive. The detection may be by flood illumination or by interrogating the carrier in a conventional way.

The term “radius of response” in the present disclosure refers to the response of the medium inhomogeneity to the interrogating/excitation beam due to the overlap between them. The overlap may be measured as a distance between the focal point of the interrogating beam and the center of the inhomogeneity. The radius of response is dependent among other factors on the size of the inhomogeneity (typically a micro-sphere) and the interrogating beam spot/shape. It is generally convenient to parameterize the radius of response in terms of Full Widths at Maximum Half-height (FWMH). The critical radius of response is the maximal radius that allows the signal to pass a detection threshold.

Particles 118 are randomly distributed in the volume of carrier 100. It may be sufficient to detect only part of the second material optical response distribution pattern, e.g. defining a signature by retrieving particles 118 locations in a two-dimensional space, for example by scanning the disc in a single plane (i.e. the same focal depth setting). A more complicate, three dimensional particles distribution pattern can be detected by a sequential scanning of depths or by direct search of the signatures from specific volume elements.

In some other embodiments of the invention, where particles 118 are passive particles or voids, their locations might be more complicate to detect as compared to those of fluorescent particles. Passive particles location detection would require resolution and accuracy higher than the fluorescent particles, since their radius of response may be smaller. However, as indicated above operating with higher resolution of determining the particle 118 locations would expand the possible number of carrier fingerprints.

Two dimensional randomized patterns can be introduced specifically in one plane during the manufacturing of a multi-plate carrier (such as disclosed in WO06075329 to the same assignee). These two-dimensional constrained pseudo-randomized inhomogeneities can be formed using an intermediate “ink jet” printing of the second material on the surface regions of at least the to-be-adhered surfaces, and can be used in the same manner as the randomly distributed particles. The advantages of controlling the size and shape of the two-dimensional pattern and a speed of access may out weigh the disadvantage of the reduced complexity (2D instead of 3D) of the fingerprint pattern and the increased manufacturing complexity.

FIG. 1C illustrates an information carrier 1000 comprising at least two plates of recording material. In the present example, two such recording plates 128 and 129 are used each including one or more data layers (virtual layers). The recording plates are spaced from one another by a semi-reflective surface (reference layer) 130, and plate 129 is spaced from a polymeric substrate material (e.g. polycarbonate) layer 131 (serving as a protective layer) by a second semi-reflective reference surface 132. It should be noted that the use of a protective layer is optional, and the configuration may be such that the uppermost recording plane (as well as the lowermost one) is located at a predetermined depth from the upper (or lower) surface of the carrier thus eliminating a need for any additional protective layer. For example layer 131 may constitute a third recording plate. The recording media of each plate includes with particles 118 distributed therein. A reading beam 150 is retrieving data from the data layers in the recording plate, and a servo beam (or reference beam) 152 is tracking one of the reference (semi-reflective) layers. Preferably (though not necessarily) the reference beam is interacting with the particles 118; as the beam overlaps the radius of response of one of the particles 118 a fluorescence signal at wavelength longer than that of the beam is emitted in response. A part of this response signal is collected by the optical unit.

FIG. 1D illustrates an information carrier 2000 of the conventional type (reflective-type carrier). The carrier 2000 includes two recording layers 153 and 155 which are (semi) reflective, and a polymeric substrate material 157 (e.g. polycarbonate) serving for protecting the reflective layer(s). Particles 118 containing of a fluorescent material (generally, a material differently responding to incident light as compared to the recording layers) are distributed in the substrate 157 to form a pattern indicative of the carrier signature. A reading beam 154 is retrieving data from the data layer 153, and as the beam overlaps the radius of response of one of the particles 118 fluorescence signal at a wavelength longer than that of the beam 154 is emitted in response to the particle interaction with the beam 154. Part of the response signal is collected by an OPU (not shown) and may be separated by well known methods such as the use of a wavelength selective (e.g. chromatic) beam splitter from the reflected beam, and directed to a dedicated photo detector.

An information carrier, configured as in either one of the above examples and containing recorded and encrypted information, is inserted in a drive and interrogated by laser radiation. The carrier fingerprint is restored (by detecting light returned from the carrier and identifying the second optical response distribution pattern or a part thereof), deciphered, the carrier is authenticated, and further use of the carrier for data retrieving purposes approved. Data retrieving is performed by following the recording/retrieving track (110 in FIGS. 1A-1B) on the selected virtual layer 114, for example by methods such as disclosed in WO05015552 and U.S. Pat. No. 6,865,142 both to the same assignee. The restored fingerprint information may be further used as a part of the deciphering key for retrieved data. The disclosed method of information retrieving further enhances carrier protection and makes information retrieval by an unauthorized drive practically impossible. The retrieving laser beam wavelength may be selected to be of the same wavelength as the interrogating and recording laser beam wavelength(s).

Signature retrieval can be performed for example by directed search for the particles according to a provided map using the OPU locating capabilities or as mentioned above by flood illumination and imaging.

It should be noted that the carrier authentication does not necessary requires interrogation by an optical beam and identification of the second material optical response pattern. The fingerprint of a carrier may be recorded in the carrier at the factory on dedicated interface regions (sectors) in the disk. An optical drive may retrieve this (possibly unencrypted) information in a conventional way. The digital data may also be authenticated by subsequent signature retrieval. Alternatively, the drive can compare the retrieved data with the downloaded and stored reference data. In case where the fingerprint of the carrier matches the recoded one, the use of the carrier is approved. If for example the downloaded data contains a key that is used for recording data and the digital signature is used in a key for retrieving data, the two keys must agree to allow data retrieval, thus providing data security. The carrier keys related data or otherwise secured DRM (Digital Rights Management) information may be downloaded periodically to each drive with associated encryption and deciphering instructions. Alternatively, the drive may request such information on-line. In addition, the download may include a revocation list, which is a list of carriers or drives which are no longer valid. This list may be further distributed on the carrier.

The storage capacity of three-dimensional carriers significantly exceeds the capacity of conventional discs. Accordingly, recording or retrieving data from such a three-dimensional carrier may take substantially more time than it takes by conventional discs.

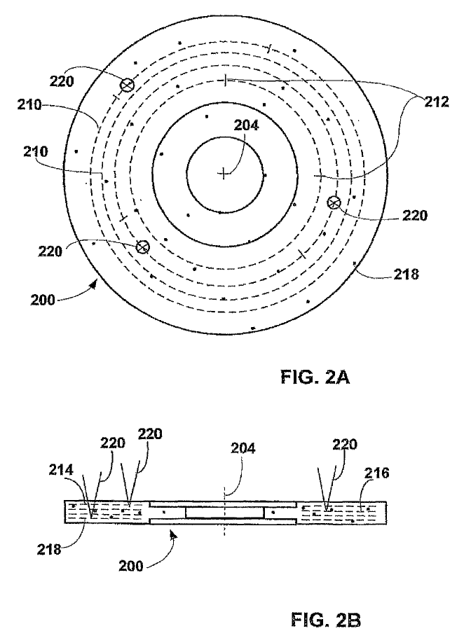

FIGS. 2A and 2B exemplify a three-dimensional carrier 200 that is rotatable around a rotational axis 204 and a plurality of optical pick-up units (OPU) shown by their laser beams 220, addressing simultaneously a number of data tracks 210 or segments 212. The simultaneously addressed segments 212 may be located on the same track 210 or on different tracks disposed in the same recording/retrieving plane within optical information carrier 200. As exemplified in FIG. 2B, a plurality of optical pick-up units (their optical beams 220) simultaneously record/retrieve data from a plurality of locations on different tracks located in different recording/reading planes 214-218 within optical information carrier 200.

Straightforward use of a plurality of optical pick-up units (OPUs) seems to be neither efficient nor secured, since the information or data recorded or retrieved has to be coordinated and this coordination opens a security gap. Accordingly, when the number of optical pick-up units is greater than one they should preferably be used in cooperation with appropriate secure methods of data recording and retrieving, as well as with management of the distribution of the data streaming load between the different OPUs. This distribution should be secured to prevent security attacks. Certain methods, known from the art of task distribution methods may be applied to coordinate this process, although optical storage has its own characteristics to be accounted for. (In addition to appropriate data coordination methods, OPU recording and retrieving speed depends on such factors as recording/reading laser diode effective power, depth and radius of recording, method of the device operation such as constant angular velocity (CAV) or zoned CAV and others.)

The present invention provides for simultaneous data (information) recording in a plurality of locations of a three dimensional information carrier by utilizing the above described carrier fingerprint encryption/deciphering information, and provides for efficient and secure encryption/deciphering of data recording/retrieving processes.

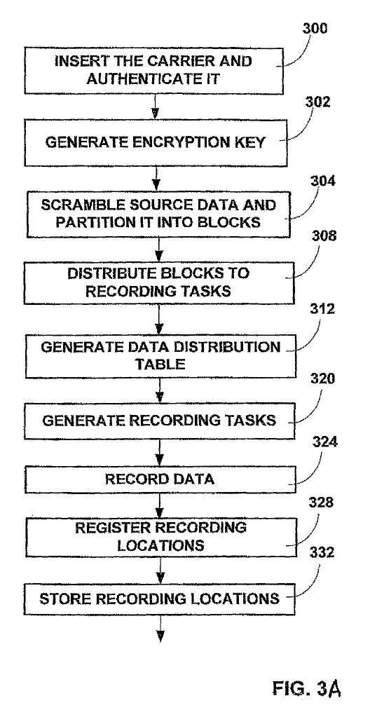

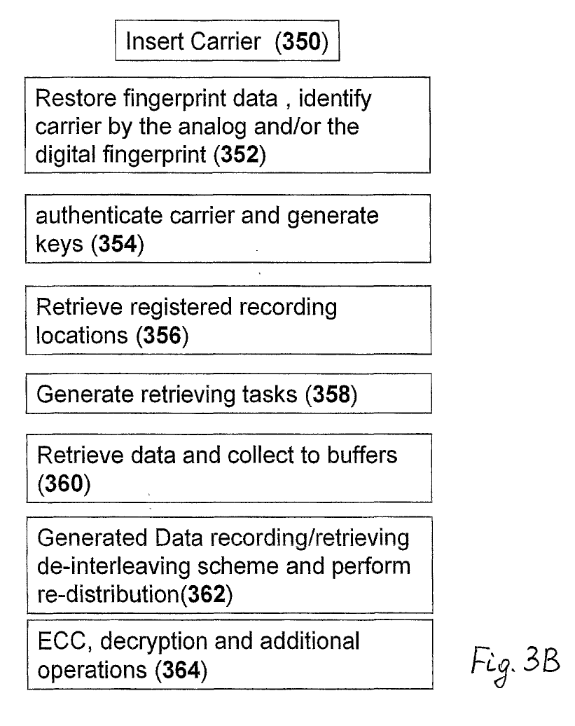

Reference is made to FIG. 3A, exemplifying the steps of a recording process. An information carrier (e.g. the above described three-dimensional carrier or a conventional reflective-type carrier) is inserted in a drive, carrier fingerprint data restored and carrier identified by reading the analog and/or the digital fingerprint and/or identity details (step 300). An encryption key is generated with the detected fingerprint data (step 302), and the disk is authenticated and source data is scrambled (for interleaving) and partitioned into a sequence of data blocks (step 304). Data scrambling for interleaving and partitioning into a sequence of data blocks may be performed using the carrier fingerprint data as part of a respective key. Data blocks are then logically distributed to recording tasks and directed to the appropriate OPU units (step 308). Data blocks recording tasks can be distributed evenly to each OPU or distributed in a more sophisticated way to the appropriate OPU, depending for example on the queues and buffers for every OPU, for example, if a plurality of OPUs serve to record and retrieve data along a similar radius track (as in the example of FIG. 2A) or recording and retrieving takes place simultaneously at different recording layers (as in the example of FIG. 2B). Optionally, the process of distributing the data blocks to recording tasks may be performed using the carrier fingerprint data as a security distribution key.

Data recording distribution table (interleaving table) is generated (step 312), for example by using a hash table. Table parameters may include a hash key or an encrypted hash key, minimal and maximal block sequence length, block sequence length variance control parameter, e.g. a randomization key and others. The hash table encryption may be dependent on the carrier fingerprint data and other encryption keys. Following this, the recording tasks are generated (step 320), and data is physically recorded (step 324) in one or multiple locations of the three dimensional optical information carrier. This can be implemented for example using recording/reading techniques disclosed in WO05015552 or IL2007/000069 both to the same assignee. Recording locations may be registered (step 328) in the data block and in an auxiliary file and stored in the drive memory. The locations may be recorded during the finalization of the recording session. In addition, recording locations may be stored (step 332) in another memory, for example, in the host computer governing the recording process or on an auxiliary flash memory. Optionally, this information may also be secured using the carrier fingerprint data as part of an encryption key.

The physical recording of data blocks may be performed by a single recording unit (OPU) that moves the beam between the various recording locations or by a plurality of recording units (OPUs) that simultaneously record data in a plurality of locations. This does not exclude a case where only one of a plurality of OPUs is operative for data recording.

Generation of an encryption key with the carrier fingerprint data, which is the second material optical response pattern, and employing this encryption key for at least one of the data recording processes such as scrambling of original data and partitioning it into recordable blocks; distributing/arranging said blocks to the recording locations; recoding secured distribution/arrangement table; generating recording blocks further enhances carrier protection and avoids non-authorized data copying. Simultaneous data recording or retrieving from a plurality of locations of the same carrier significantly improves the data recording retrieving speed.

The method of data recording disclosed supra enhances the reliability of the recorded data since it enables interleaving of the source data, encrypted or not-encrypted, in different recording blocks, and optionally at different interleaving rates and distribution of the recorded data including error correction information into different locations. Faulty data blocks are easier to correct using data interleaving and de-interleaving, because as is well known in the art of error correction codes (ECC), these “smaller” (distributed) errors have a higher probability of being corrected than a complete faulty block, especially if the number of errors in each error-correcting block is below certain threshold established by the ECC used. In this context of the present disclosure, the term ‘protection’ refers to a combination of security and reliability. The method therefore provides for data and carrier protection.

Simultaneous data retrieving from a plurality of locations of a three dimensional optical information carrier is performed in a similar way. All or at least one of the data retrieving processes such as unscrambling the recorded data and distributing it into retrievable blocks; distributing/rearranging the blocks to the relevant retrieving locations; retrieving recording distribution table; restoring recording blocks; restoring the hash table, employ a deciphering key dependent on the carrier fingerprint data, which is the second material optical response pattern information.

Reference is made to FIG. 3B, exemplifying a method of a (secured) data retrieving process, by one or more OPU. An information carrier (e.g. the above described three-dimensional carrier or a conventional reflective-type carrier) is inserted in a drive (step 350). The carrier fingerprint data is restored, and the carrier is identified by reading the analog and/or digital fingerprint and/or identity details (step 352). The carrier is authenticated, and a decryption key is generated with the fingerprint data (step 354).

Recording locations registered for example in the data block and/or in an auxiliary file are retrieved (or pointed to), decrypted if required, and stored in the drive memory or another memory, e.g. host computer or auxiliary flash memory (step 356).

Following this, the data retrieving tasks are generated (step 358). Data blocks retrieving tasks are coordinated between the more than one OPU (as the case may be), depending for example on the sizes of the expected data sequences and on the queues and buffers for every OPU, and data is physically retrieved from one or multiple locations of the three dimensional optical information carrier. Then, data is collected into appropriate buffers (step 360).

Data recording/retrieving re-distribution table (de-interleaving table) is generated (being optionally dependent on the carrier fingerprint data and other encryption keys), and data descrambling and reordering into a sequence of data blocks is performed (step 362). The carrier fingerprint data is optionally used as part of a respective key.

Data error correction and detection, and data decryption and additional conventional operations are then performed (step 364).

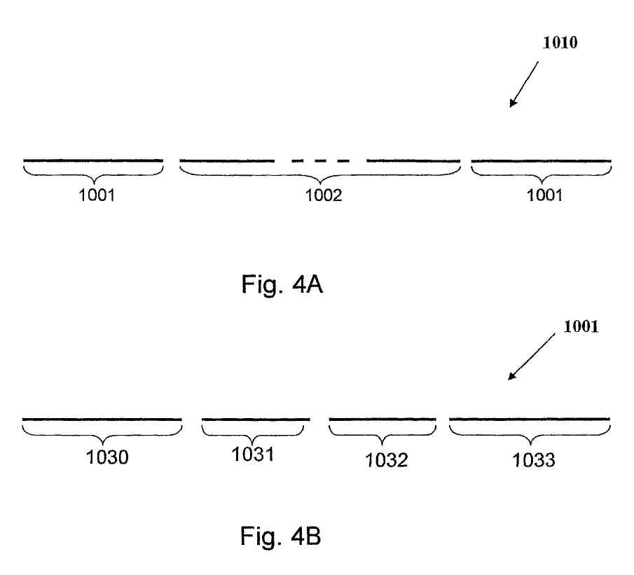

FIG. 4A shows an example of a track sector structure 1010 suitable to be used in the present invention. Track sector 1000A includes a header part 1001 containing information regarding an identification ordering number for the recordable block to allow for reorganization of data blocks 1002 distributed in various locations in the information carrier, by at least one recording OPU. The reorganization data may be encrypted and may be repeated (in addition to being registered in the file system) a few times in the sector to increase retrieval reliability.

FIG. 4B illustrates in more detail the content of the header part 1001. The latter includes a physical address field (sector, zone layer) 1030, a file ID field 1031, a block numbering within the file 1032, and a synchronization field 1032. Other fields not exemplified may also be part of the block header.

In addition to carrier fingerprint based encryption, other conventional data protection methods, such as data cross-linking of logical order of the data blocks with the physical locations recording of auxiliary data in dedicated locations along the track, or in combination with the recorded data blocks and others, may be used. In the context of the present text, “linking” means that the data block or block header contains information that points to the logical and physical location of the next block; “data cross-linking” means that the information is pointing not only forward to the next logical or physical block but also to other relevant blocks in the data steam. Non-limiting examples of data cross-linking include previous data block, previous or next frame scene, parallel video/audio stream or other meta-structures of the data stream.

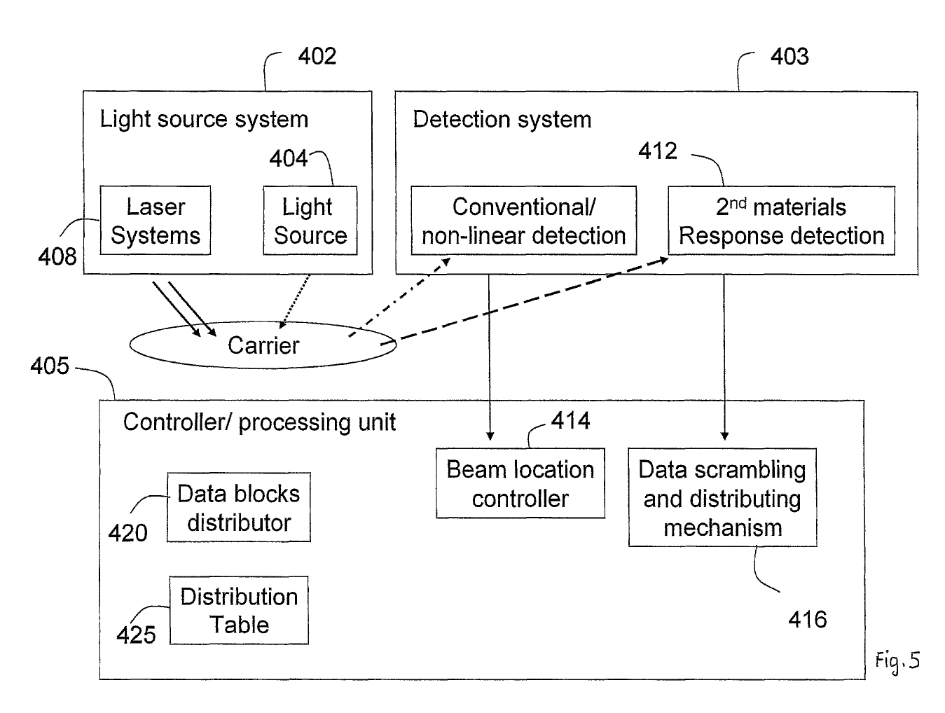

Reference is made to FIG. 5 illustrating, by way of a block diagram, an example of an apparatus, generally designated 400, for simultaneous data (information) recording or retrieving in a plurality of locations of a three dimensional information carrier. Generally, apparatus 400 is configured similar to the known optical disc drives/apparatuses. Apparatus 400 includes a light source system 402, a detection system 403, a controller utility 405. Light source 402 may include the same laser source 408 for carrier interrogation (i.e. identification of the carrier fingerprint for authentication) and data recording (i.e. substantially the same wavelength is used for both procedures), otherwise the light source system includes a second light source 404 (not necessarily a laser) for authentication purposes. Detection system 403 includes a mechanism 412 for detecting the carrier fingerprint (the second material optical response pattern), and generating with the detected pattern the required encryption/decryption keys. This mechanism may for example include an optical filter for specific wavelength range, conventional photo detection to forward the signal to a processing unit which also receives beam location information from a beam location controller 414 performing the beam tracking mechanism which may be of the conventional type. Controller utility 405 includes inter alia a mechanism 416 for employing the encryption key for scrambling original data and distributing it into recordable blocks; mechanism 420 for distributing the blocks to the recording locations; mechanisms for generation of the recoding distribution table, recording blocks and a hash table 425.

As indicated above, in some other embodiments, the fingerprint of each carrier may be detected and recorded in the carrier at the factory. In this case, the drive may retrieve this information in a conventional way and compare it with the downloaded and stored in the drive memory information. Accordingly, the apparatus 400 would further include an additional separate memory utility (not shown) or a section of drive memory would be allocated to store factory generated carrier fingerprint and associated with it encryption/deciphering data. Alternatively, the downloaded carrier fingerprint and associated with it encryption/deciphering data may be stored in a host computer (not shown). The carrier fingerprint information may be securely downloaded to the drive with associated encryption and deciphering instructions.

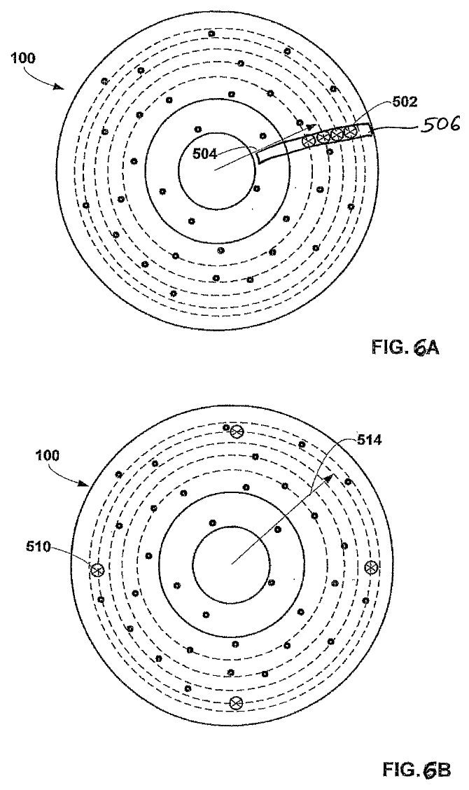

Reference is made to FIGS. 6A and 6B exemplifying how the arrangement or ordering of the OPUs affects data recording/reading. As illustrated in FIG. 6A, OPUs 502 (shown by respective laser beam spots) may be ordered in a certain sequence with respect to a radial direction 504 of an information carrier (disk) 100. Such ordering makes it possible to have different data recording speeds for the different OPUs, thus improving the overall data rate. The ordering of OPUs 502 can be performed at the assembly time on a coordinating sled 506. Alternatively, as illustrated in FIG. 6B, a plurality of individual OPUs 510 may be directed to different locations on the same radial direction 514 of the carrier 100. Other OPU ordering schemes are possible.

The retrieval of a particular file from a three dimensional storage medium requires the retrieval of the block sequences information, which further requires deciphering the information of the table or of the file. Even with mild security measures, it is possible to make the deciphering difficult enough to prevent unauthorized copying of the storage media content, either because bit to bit copying requires uneconomically large time frames or because data deciphering requires impractical large resources. Carrier fingerprint based encryption implemented on one or more of listed processes practically makes data deciphering and adversary data retrieval impossible and significantly improves data protection.

The following are some examples of material selection and preparation of micro particles.

Cross linked material for the micro particles can be prepared in a casting procedure. A cast block can be manufactured by copolymerizing of 40% wt eMMA or eAA, 50% methymethacrylate (MMA) and 9% wt of a cross-linker (not counting initiator) and 1% fluorescent dye such as those provided in the table below. Possible initiators are BPO (azoisobutyronitrile), AIBN and similar. Cross linking agent may be the following compound:

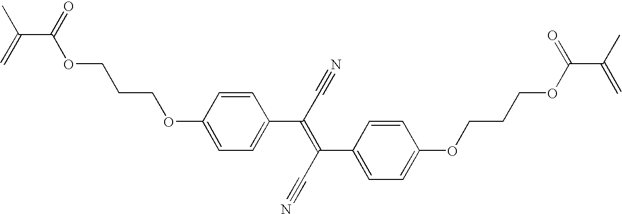

[2-Methyl-acrylic acid 3-[4-(1,2-dicyano-2-{4-[3-(2-methyl-acryloyloxy)-propoxy]-phenyl}-vinyl)-phenoxy]-propyl ester; preparation given in WO 03/070689].

The casting process is disclosed in WO 2006/075327 to the same assignee, which is incorporated herein by reference.

According to some other examples, cross linking agent may be low percent of acrylate cross-linking agents such as ethylene glycol dimethacrylate.

This system may be recorded and retrieved with a laser having emission between 630 to 680 nm. In these examples, dyes are considered for interrogation in wavelengths ranging from 630 nm using the first wavelength to 780 nm and above using a second source for the second wavelength.

A methacrylate-linked dye may be copolymerized with MMA and eMMA to give a monolith, which will be ground to give microspheres of ca. 20-50 micron diameter. Assuming that each disk needs an average of 100 beads, this means that 1 mg of dye is sufficient to manufacture enough beads for at least 1,000 disks and it is more likely that 1 mg would provide 1,000,000 disks.

For the appropriate fluorophore (dye) selection, such factors as dye absorption and fluorescence spectra, functionalization, concentration, fluorescence quantum yield, exciting signal power for fluorophores in micro-spheres, should preferably be considered. In this connection, the following should be noted:

Fluorescent dyes that are active in the near-IR (e.g. 780 nm), tend to have a low quantum yield of fluorescence. In particular, quantum yield (φ) and photostability are of concern, however if low φ can be endured, it is be possible to use relatively simple dyes.

For stability and to avoid dye diffusion, the dye should preferably be covalently linked to polymerizable group, which will then be copolymerized to form the (acrylic) matrix e.g. using MMA, possibly eMMA, and a crosslinker to provide insoluble disk material with the (functionalized) fluorescent dye. Most commercial fluorophores can be purchased as reactive functionalized species. Typically, these are succinimide (or other activated) esters, isothiocyanates, amines, or carboxylic acids. Methaacrylate functionalized dyes are also often commercially available.

Assuming for example, a dye with absorbance coefficient ε=100,000 cm²M⁻¹ and MW=1000 is used, a 0.01 g L⁻¹ solution would give an OD of 1 (T=10%) in a 1 cm cell (or 0.01 g cm⁻³ in a 10 micron film). So, micro-spheres of ˜20 microns radius (the radius is important to determine the optical path length within the micro-sphere) would absorb 99% of incident light with a fluorophore concentration of 1 wt %. If lower absorbance is required, the fluorophore concentration would be reduced down to ˜0.01 wt %. An alternative is to utilize a dye that has its absorbance tail at a second wavelength. If a relatively low absorbance is needed, and therefore very low dye concentration, a higher concentration of dye with an absorbance maximum at a much lower wavelength could alternatively be used, but with some tail-end absorbance at 780 nm. For instance, some dyes with an absorbance maximum at 725 nm might still have an extinction coefficient of 1,000 cm²M⁻¹ at 780 nm.

Signal power can be very low because the required bandwidth for the detection of the micro-spheres is very low, on the order of KHz or less.

According to the above model, the 1 wt % bead contains 10⁸ molecules, and the 0.01 wt % bead contains 10⁶ molecules. Assuming a fluorescence lifetime (therefore turnover rate) of 1 ns for each molecule, the maximum fluorescence output of a single bead would be around 1 W (1 wt % beads) or 10 mW (0.01 wt % beads).

Hence, it is possible to reach required signal strengths in either case, providing that a powerful enough excitation source is used.

Roughly speaking, the light (laser) power required is proportional to the signal strength required at the detector, the collection efficiency, and the quantum yield (φ) of fluorescence, and is inversely proportional to the fraction of laser light that is absorbed by the micropshere.

For example, the use of a 10 mW laser and a ‘low-absorbance’ microsphere would provide 1 mw of excitation energy. If the system uses a dye with φ=0.5 and a detector with 1-5% collection efficiency, then the 10 mW laser would bring 0.05-0.25 μW of signal to the detector, more then enough at the required bandwidth. Using stronger laser or direct use of the recording or retrieving high power laser(s) practically guaranties that enough signal power will be available.

The following table presents some examples of dyes for incorporation in micro spheres:

| | Molecular | λ_{max,} | | | λmax,e | | |
|---|---|---|---|---|---|---|---|
| Dye | weight | abs | ε₇₈₀ | ε₇₈₀ | m | φ_{f1} | Notes |
| FD11 (Enamine) | 683 | 780 | 114,000 | | | | This is an amine and |
| | | | | | | | an ammonium salt. |
| | | | | | | | MW does not include |
| | | | | | | | counter-ion. |
| Alexa Fluor 750 | | 749 | ~25,000 | | 775 | | |
| Atto-Tec 680 | | 675 | low | | 699 | 0.4 | |
| DiR | 1013 | 748 | ~50,000 | | 780 | | Cyanine dye, |
| | | | | | | | ammonium salt. |
| ADS775PI/IR- | 900 | ~780 | 250,000 | ~50,000 | 822 | | Cyanine dye, |
| 780 (A.K.A. Cy7) | | | | | | | ammonium salt. |
| WellRED D2-PA | 611 | 750 | ~30,000 | | 780 | | |
| FAR-Green | | | | | | | Mentioned in US |
| | | | | | | | 20030228609 |
| ADS-790-NS | | | | | | | Mentioned in US |
| | | | | | | | 20030228609 |
| DY-780- | | 780 | ~70,000 | | 820 | | |
| methacylate | | | | | | | |

The ADS775PI/IR-780 dye (IV) (also known as CY7) supplied by Aldrich (catalog# 42, 531-1) can be functionalized by Sn2 reaction of the Cl as described in diagram (V):

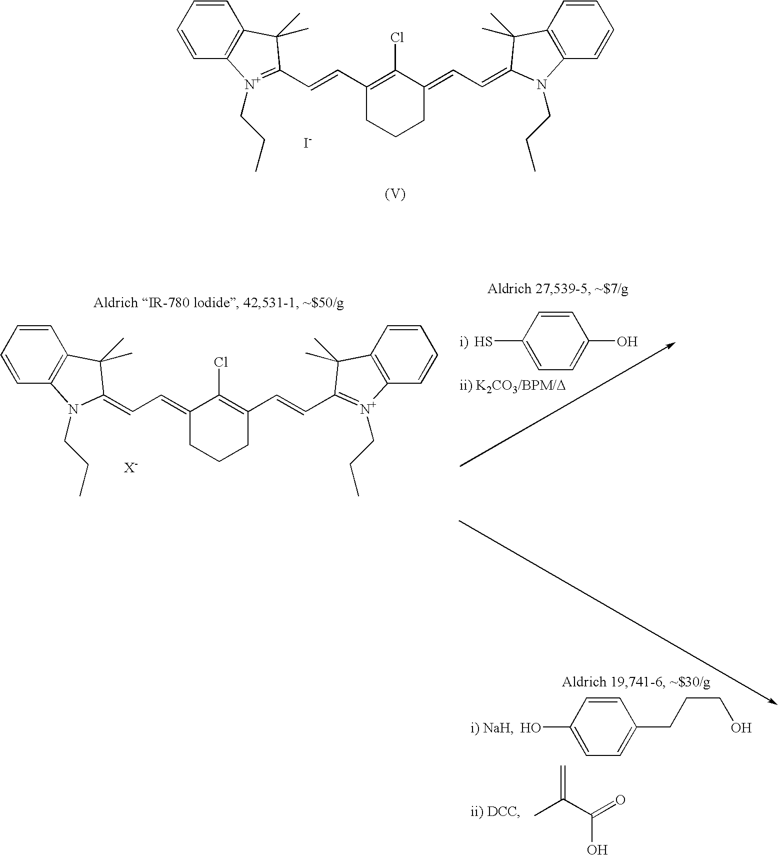

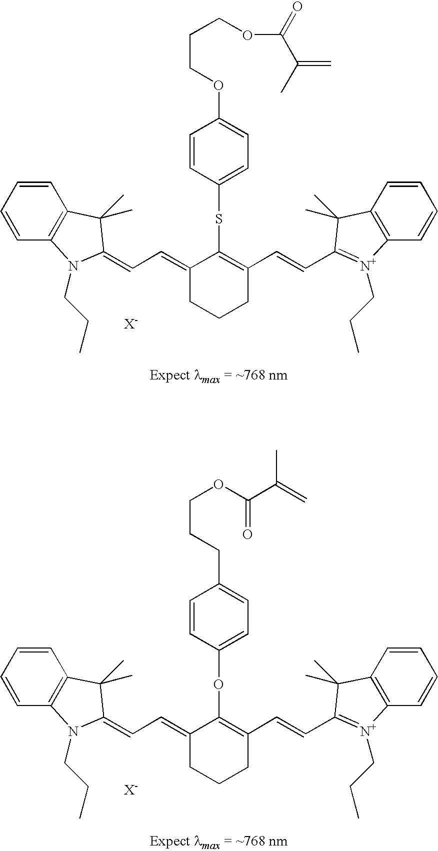

This dye family has a very large number of members and one of the most organic-soluble one. The optical parameters are dependant on the substitution at the central position. A thiol gives an absorbance maximum at 790 nm, chloride gives 780 nm, an ether gives 770 nm, a phenyl group gives ˜760, and H gives ˜750. Displacement of the chloride is an S_{RN}1 reaction is given in [Flanagan et. Al, Bioconjugate Chem. 1997, 8, 751-756].

DY-780-methacylate (Dyomics GMBH) is for example soluble in CHCl₃ and in other “less polar” solvents. As indicated above, measurement of the second material optical response may be carried out by measuring the fluorescence of the microspheres, or by measuring absorbance thereof by collecting light as it exits the carrier and measuring its modulation. The latter case provides for much wider and cheaper selection of dyes to choose from, because φ_{fluorescence} is irrelevant, and also provides for collecting almost 100% of the signal.

While this invention has been particularly shown and described with references to preferred embodiments thereof, it will be understood by those skilled in the art that various changes in form and details may be made therein without departing from the scope of the invention encompassed by the appended claims.

What is claimed is:

1. An optical information carrier comprising a recording medium comprising:
a first material configured for recording and reading data therein in the form of a first data pattern recordable and readable as a result of multi-photon interaction and configured to provide a first optical response to incident light; and
a second material excitable by one- or multi-photon interaction and being embedded and randomly distributed in said recording medium to form a second random pattern responding to incident light by a second optical response different from the first optical response, the random pattern forming the second optical response pattern being indicative of an individual and identifiable carrier specific signature.

2. The carrier of claim 1, wherein said second random pattern is indicative of a data encryption/decryption key.

3. The carrier of claim 2, wherein said key corresponds to a predetermined arrangement of data blocks to be used in creation of said first data pattern.

4. The carrier of any claim 1, wherein the recording medium is a non-linear medium having a fluorescent property thereof variable on occurrence of multi-photon absorption resulted from interaction with an optical beam.

5. The carrier of claim 1, wherein the second pattern forming the second optical response pattern is in the form of particles embedded in the recording medium.

6. The carrier of claim 5, wherein the particles embedded in the substrate comprise micro-spheres.

7. The carrier of claim 5, wherein the particles are configured to provide a detectable optical response to incident light different from that of the first pattern regions.

8. The carrier of claim 7, having one of the following configurations: (i) the particles respond to the incident light by optical response of a wavelength different from that of the first pattern regions; (ii) the particles comprise an optically active material different from the optically active material of the recording medium; and (iii) the particles comprise an absorbing material providing the detectable optical response to incident light different from that of the first pattern.

9. (canceled)

10. (canceled)

11. The carrier of claim 7, wherein the particles comprise an absorbing material providing the detectable optical response to incident light different from that of the first pattern said absorbing material comprising a fluorescent material with fluorescence of a wavelength different from that of the first material.

12. The carrier of claim 1, wherein the recording medium comprises a first material having the first optical response to the incident light; and inhomogeneities distributed in the first material and being introduced by a second material having a second different optical response to an optical beam, the distribution of said inhomogeneities presenting said second random pattern forming the second optical response pattern being indicative of the individual and identifiable carrier specific signature.

13. The carrier of claim 12, wherein said second optical response is fluorescence.

14. The carrier of claim 12, wherein said first optical response is fluorescence induced by the first material interaction with the optical beam.

15. The carrier of claim 13, characterized by one of the following: (a) the fluorescence of the first and second optical responses are of different first and second wavelengths respectively; (b) the fluorescence of the first and second optical responses are of different first and second wavelengths respectively, the first and second optical responses being inducible by the same wavelength of optical beam; and (c) the first and second materials are selected such that the first and second optical responses are inducible by the same wavelength of optical beam.

16. (canceled)

17. (canceled)

18. The carrier of claim 1, wherein said multi-photon interaction comprises two-photon absorption.

19. The carrier of claim 1 configured for recording and reading data in the form of a three-dimensional pattern of spaced-apart recorded regions located in multiple virtual planes.

20. The carrier of claim 12, wherein the inhomogeneities comprise particles including the second material.

21. The carrier of claim 20, wherein said particles include at least some ingredients of the first material.

22. The carrier of claim 20, wherein the recording medium is a mixture of the first material and the particles.

23. The carrier of claim 20, wherein said particles are introduced into specific locations within the first material.

24. The carrier of claim 1, wherein said second optical response distribution pattern is indicative of a private key of data stored in the carrier.

25. An optical information carrier, comprising a recording medium formed of a first material having a first optical response to an optical beam; and inhomogeneities embedded in and randomly distributed in the first material and being introduced by a second material having a second different optical response to an optical beam, the random distribution of the inhomogeneities forming the second optical response distribution pattern which is indicative of an individual and identifiable carrier specific signature and at least a part of said second optical response pattern is indicative of an encryption key corresponding to a predetermined arrangement of data blocks to be used in creation of a data pattern of the first optical response.

26. A method of securing an optical information carrier, the method comprising: providing in a recording medium of the carrier a first material in which data is recorded and read as a result of multi-photon interaction and inhomogeneities of a second material embedded in and randomly distributed in the first material, the second material being excitable by one- or multi-photon interaction, the first and second materials having different optical responses to electromagnetic radiation, enabling detection of the second optical response distribution pattern, said second optical response distribution pattern being indicative of an individual and identifiable carrier specific signature and enabling employing said signature for securing the use of at least one of an optical drive, data and data carrier.

27. The method of claim 26, wherein said data is recorded in or retrieved from a plurality of locations simultaneously.

28. The method of claim 26, wherein the second optical response distribution pattern is indicative of a key for encryption/decryption recorded data.

29. The method of claim 28, wherein said key corresponds to a predetermined arrangement of data blocks to be used in creation of the data pattern.

30. The method of claim 29, providing for protecting data recording-in and retrieving-from a plurality of locations in the information carrier of claim 1, the method comprising:
employing said key embedded in the second optical response pattern to arrange data into recording tasks;
registering and directing the recording tasks to a plurality of locations in the carrier;
retrieving the register and retrieving data from a plurality of locations on the carrier, and;
employing said carrier signature to protect at least one of data, data distribution and task registration.

31. The method of claim 29, for data interleaving for recording and retrieving data in the information carrier of claim 1, said method comprising:
acquiring the carrier signature;
using said signature for generating an encryption/decryption key, and
employing said key for encryption of interleave locations addresses.

32. A method for use in recording data to or retrieving data from an optical information carrier by using at least two optical units, the method comprising: identifying a carrier specific signature embedded in a recording medium of the carrier and using said carrier specific signature for coupling between at least two concurrently performed data recording processes or at least two concurrently performed data retrieving processes.

33. The method of claim 32, comprising protecting the optical information carrier, by utilizing at least a part of said signature as a key to secure data recorded in said carrier by said at least two optical units, thereby enabling enhanced data security and protection.

34. The method according to claim 32, wherein the identified signature is used as a key to distribute data among the at least two optical units.

35. A method for use in recording data in an optical information carrier, the method comprising identifying a carrier specific signature embedded in the carrier and using said carrier specific signature for managing arrangement of data blocks being recorded.

36. An optical apparatus for data recording-in and retrieving-from the information carrier of claim 1, the apparatus comprising at least one optical unit comprising: an electromagnetic radiation source system configured and operable to irradiate the carrier with at least one optical beam to cause the first and second different optical responses from the carrier; an electromagnetic radiation detection system configured and operable for detecting the second optical response pattern and generating data indicative of the random pattern, and a controller utility configured and operable for receiving and analyzing data indicative of the random pattern to derive the carrier signature and to use at least a part of said derived signature for managing arrangement of data blocks being recorded.

37. The apparatus of claim 36, characterized by one of the following: (1) the electromagnetic radiation source system comprises the same light source for irradiating the carrier to cause the first and second optical responses; (2) the electromagnetic radiation source system comprises first and second light sources for irradiating the carrier to cause the first and second optical responses respectively; (3) the controller utility is configured and operable to provide data recording or data retrieval from a plurality of locations simultaneously; (4) at least one additional optical unit is provided the controller utility being configured for operating the at least two optical units to provide data recording or data retrieval from a plurality of locations simultaneously.

38. (canceled)

39. (canceled)

40. (canceled)

41. The apparatus of claim 36, comprising at least one additional optical unit, the controller utility being configured for operating the at least two optical units to provide data recording or data retrieval from a plurality of locations simultaneously, by carrying out at least one of the following: utilizing at least a part of the derived signature as a key to secure data recorded in said carrier by said at least two optical units; and utilizing at least a part of the derived signature as a key to distribute data among the at least two optical units.

42. (canceled)
